(19) United States
(12) Patent Application Publication
(10) Pub. No.: US 2005/0141346 A1
(43) Pub. Date: Jun. 30, 2005

(54) Smoking cessation device

(76) Inventors: David K. Rawls, Imperial Beach, CA (US); Rebecca Rawls, Imperial Beach, CA (US); Allan L. Ross, San Diego, CA (US); William D. McWhirter, Mason, OH (US); John S. Weaver, Cincinnati, OH (US); Paul R. Jordan, Blanchester, OH (US); Anthony A. Sucec, Coronado, CA (US)

Correspondence Address: FISH & RICHARDSON, PC, 12390 EL CAMINO REAL, SAN DIEGO, CA, 92130-2081, US

(21) Appl. No.: 10/839,972

(22) Filed: May 5, 2004

Related U.S. Application Data
(63) Continuation-in-part of application No. 10/801,945, filed on Mar. 15, 2004, now abandoned.
(60) Provisional application No. 60/533,828, filed on Dec. 30, 2003.

(51) Int. Cl. G04B 47/00

(52) U.S. Cl. 368/10

(57) ABSTRACT

A portable device, such as a pager-type device or card module, generates and guides a user through a customized smoking cessation plan. The device calculates intervals between smoking events (when the user is allowed to smoke) based on user input information and the day in the plan. The intervals increase as the plan progresses. The device alerts the user when a smoking event occurs. The user may place the device in a silent mode during periods when smoking would be inconvenient.

### CROSS-REFERENCE TO RELATED APPLICATIONS

This application claims priority to U.S. Provisional Application Ser. No. 60/533,828, filed on Dec. 30, 2003, and is a continuation-in-part application of U.S. application Ser. No. 10/801,945 filed Mar. 15, 2004.

### BACKGROUND

The present disclosure relates to software and hardware methods and/or tools to aid in a cessation of an addictive habit, such as using tobacco products.

Oftentimes, users of addictive products, such as tobacco products, can find it difficult to stop their habit. For example, smokers of tobacco products may have a chemical addiction to tobacco that can inhibit their attempts to quit smoking. The chemical addiction may cause one or more withdrawal symptoms, such as irritability and nervousness. Instead of quitting their use of addictive products all at once, smokers may wish gradually reduce their use of the product over time, and thus, gradually reduce their chemical addiction and modify their addictive behaviors.

Smokers may use one or more tools to help aid in the gradual cessation of tobacco use. Some of these cessation tools may include chemical products that can help to reduce the chemical addiction over time, such as nicotine patches. Other cessation tools can provide visual and/or audible reminders to help smokers keep track of their tobacco use, and to reduce that use over time.

### SUMMARY

A portable device, such as a pager-type device or card module, generates and guides a user through a customized smoking cessation plan. The device calculates intervals between smoking events (when the user is allowed to smoke) based on user input information and the day in the plan. The intervals increase as the plan progresses. The device alerts the user when a smoking event occurs. The user may place the device in a silent mode during periods when smoking would be inconvenient.

The systems and techniques described here may provide one or more of the following advantages. For example, a user who is addicted to tobacco products can reduce their use of tobacco products over time with a portable device. The portable device can allow the tobacco user to monitor their tobacco use throughout the day and provide stimuli to promote gradual cessation of tobacco use. Such stimuli may include audible stimuli (e.g., ringing or tone), visual stimuli (e.g., a flashing indicator), and physical stimuli (e.g., vibrations). The portable device and/or its related stimuli may be customizable to coordinate with the user's schedule and activities. The portable device can be physically non-obtrusive and may be wearable (e.g., a pager-type device) and/or easily transported (e.g., a credit card-size portable device).

Another advantage can include allowing a user of tobacco products to have a software program on their existing portable devices (e.g., a pager, or a personal digital assistant—PDA). The software can be easily coordinated within their schedule and/or may co-exist with another program or tool (e.g., Outlook by Microsoft of Redmond, Wash.). The smoking cessation tool can easily be downloaded and operated on computer or electrical equipment.

Details of one or more implementations are set forth in the accompanying drawings and the description below. Other features and advantages will be apparent from the description and drawings, and from the claims.

### DRAWING DESCRIPTIONS

FIG. 1A shows an exemplary diagram of a cessation device.

FIG. 1B shows an exemplary diagram of a cessation device display.

FIG. 2 shows an exemplary smoking cessation architecture.

FIG. 3 is a diagram of an exemplary power up sequence.

FIG. 4 shows an exemplary algorithm for settings and calculations in the smoking cessation plan.

FIG. 5 shows an exemplary main operating algorithm of the smoking cessation plan.

FIGS. 6A and 6B show exemplary flowcharts of silent mode operations.

FIG. 7 shows an exemplary diagram with the latest time set in a day.

FIG. 8 shows an alternative embodiment in which the smoking cessation software runs on a central server in wireless connection to the user's device.

Like reference symbols in the various drawings indicate like elements.

### DETAILED DESCRIPTION

The present disclosure provides techniques, tools, and interface(s) to present clear and easy-to-understand tools to help a user of addictive tobacco products to gradually reduce, and eventually cease the use of such products. In one implementation, the cessation tool includes an algorithm that can be implemented on a computer or electronic device to help the tobacco user monitor a reduction of tobacco use over time. The computer or electronic device can be a portable device, such as a pager-type device, that can be worn or easily carried by the user. The device may also be generally referred to as a portable and/or personal cessation-type device. The algorithm may include a plan in which smokers are allowed to smoke a specified number of cigarettes at specific times of the day over a 30-day period. For each week in the plan, the number of allowed cigarettes per day is reduced. Among other functions discussed below, the computer or electronic device can (1) help the user to keep track of their progress, (2) remind the user of an allowable time to smoke, and (3) allow the user to customize a plan around the user's daily schedule.

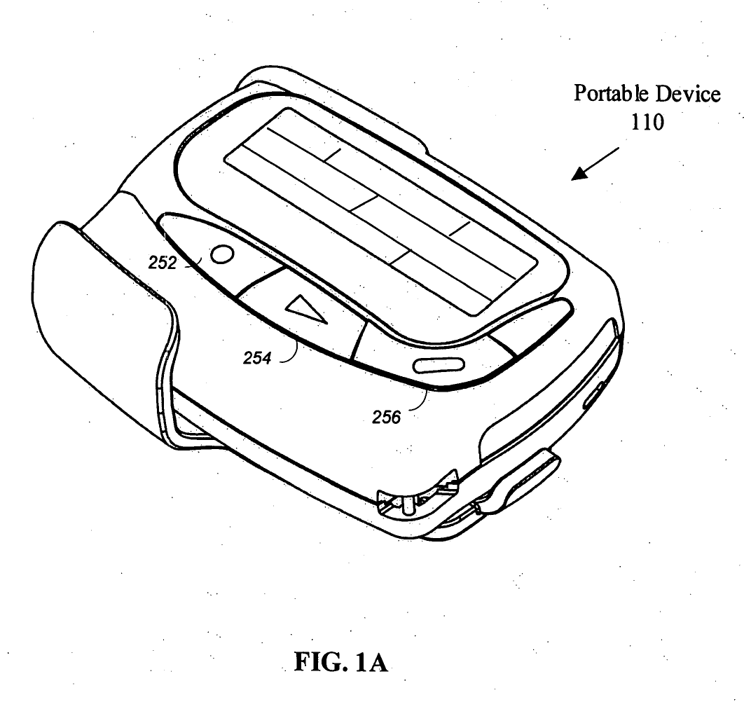

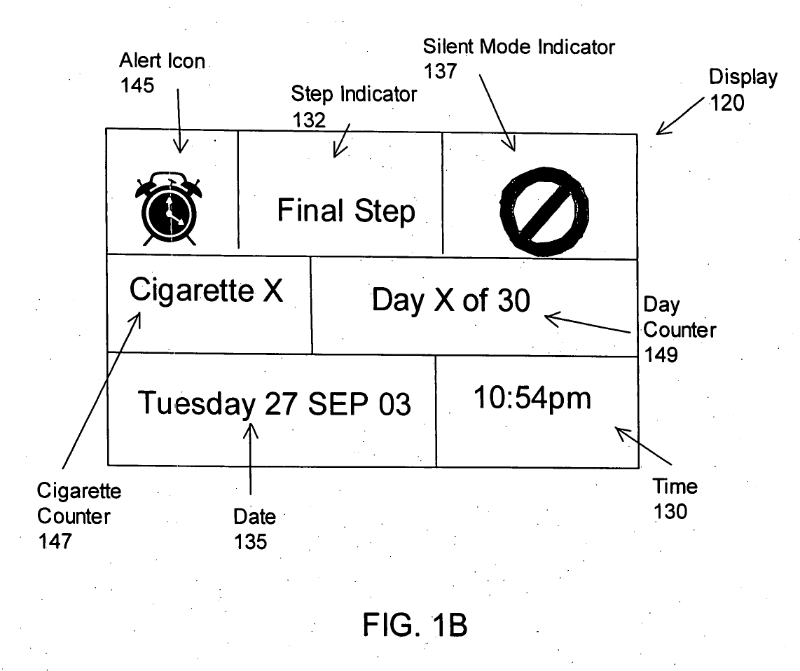

FIGS. 1A and 1B show an example of a portable device 110 (FIG. 1A) with an exemplary display 120 (FIG. 1B) that can include visual information for a user of the device. The device 110 is shown as a pager-type device in this example, but may also be implemented as other devices that have the properties of having (1) portability and (2) a display. As will be discussed below, the device may include other means of providing information or stimuli to the user, including audible indicators (e.g., voice or tone indicators) and physical stimuli (e.g., vibrations of the device). The device can have one or more buttons for editing settings, and one or more input/output (IO) ports to provide for data communication among other electrical or computer devices. The device may also have wireless and/or cordless data communication capabilities. The device can be configured to operate one or more smoking cessation algorithms.

The display 120 can include one or more sources of information for the device user. The display 120 may include an indication of the progress of the device user in reducing tobacco use. For example, the display 120 can include a step indicator 132 to indicate which step the user is in the process of quitting the habit of smoking. The display 120 can have one or more status indicators 137, 145 of alerts. For example, an alert icon 145 can indicate if the device 110 will make an audible alert (e.g., a beep or tone) at specific intervals. The display 120 can also have a silent mode indicator 137 to show when the audible alert is turned off. The display 120 can include a cigarette counter 147 to show the number of cigarettes smoked and/or allowed for smoking in a day. A day counter 149 shows the number of days in a cessation plan and the current day in that plan. The display 120 can also include showing other temporal features, such as a date 135 and a current time 130. The device can present a display of one item (e.g., 132) or any combination of items (e.g., 135, 130, 147, 149), and the user can select which item(s) to display by toggling a selector or button on the device.

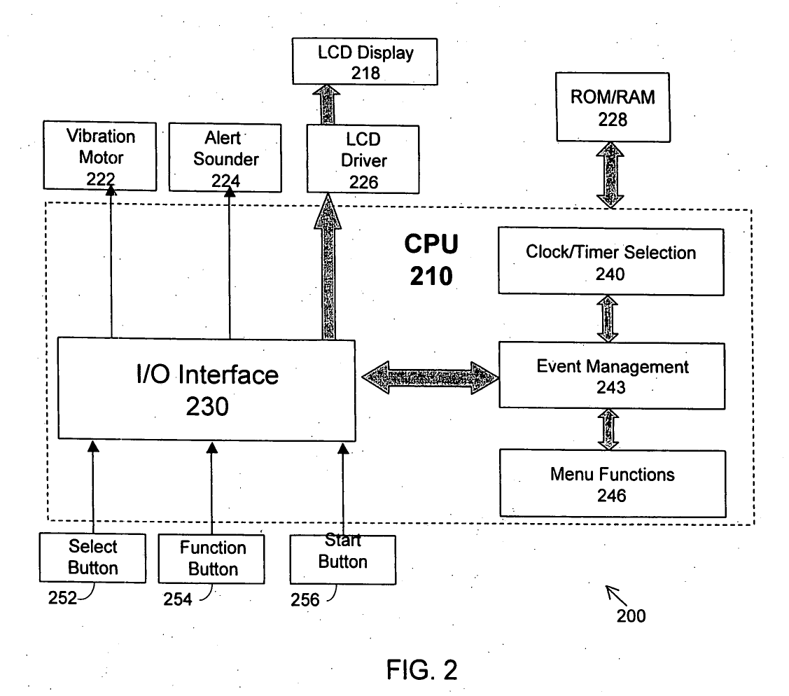

FIG. 2 shows an exemplary implementation of a smoking cessation architecture. The exemplary architecture includes a processor (e.g., a central processing unit (CPU) 210), input buttons and selectors (e.g., buttons 252, 254, 256), alert indicators (222, 224), memory 228, and a display 218.

The CPU 210 may have an input/output (I/O) interface 230 to receive inputs from an input device (such as a mouse or touchpad) and/or the buttons (252, 254, 256). The buttons can be of any size, color, or shape, and may include one or more lighted portions. The I/O interface 230 can also have one or more outputs (222, 224, 226). The one or more outputs can include audible indicators 224 (e.g., beeping, honking, clicking, chirping), visual indicators 218 (e.g., flashing lights and icons, text messages), and/or physical indicators 222 (e.g., moving parts to create vibrations) to alert and/or interact with the user. The architecture 200 can include a motor for vibrations and a LCD (liquid crystal display) driver for the LCD display control 218.

The I/O interface 230 can also intact with other functions and features within the CPU 210. For instance, the CPU 210 may have a feature 243 to manage various events, such as date and alarm settings. One or more menu functions 246 may be provided to allow the user to select items from a variety of user modes (e.g., a power up mode) and to select various user settings (e.g., a latest start of day setting). The processor 210 may also be capable of including one or more clocks, timers, and/or counters 240. The clocks can include a time of the day, week, month, and/or year, as well as a time period within a smoking cessation plan (e.g., day 8 of the 30-day plan). The timers and/or counters may include a timer that counts down the number of days in the plan, the time intervals in the day the user is permitted to smoke, the number of times a day the user is allowed to smoke, and/or the number of times the user has already smoked in the day.

The architecture 200 may also include circuitry for storage, such as a read-only memory (ROM) and/or random access memory (RAM). In general, the architecture 200 may include one or more features that can be implemented either in software or hardware. For example, the menu features 246, event management 243, and the counters or timers 240 can be implemented in either hardware or software. One or more procedures, modes, and methods described below may also be operated and/or implemented in either hardware or software.

Device Buttons

The device can include one or more buttons to add or modify settings and data. For example, the device may have one or more buttons to set the start of the day (e.g., 6:30 am) for monitoring smoking habits, or for setting times the device should remain silent (e.g., when the user is in a meeting). In one implementation, the buttons can be depressed for at least three seconds to activate the settings and to avoid inadvertent activations. A “Start” button 256 may have a green color and may be used to acknowledge or confirm the start of the day for monitoring. If the Start button is depressed for three seconds then the start of the day for monitoring can be reset to a default value (e.g., 6:30 am). A “Select” button 252 may have a red color and can be used to set a menu function or the time of the day designated for silent time. The device may also have a “Function” button 254 in the shape of an arrow that can be used to invoke a menu to set the time and date. The Function button can also be used to select between an audible alert (e.g., beeping or chirping) or a physical alert (e.g., vibrations). The alert set with the Function button may end after a time out period of two minutes or by using another key to exit the time and date menu. When the Function button is depressed for 3 seconds, a backlight in the device may turn on for a period of time (e.g., around 30 seconds).

Power Up

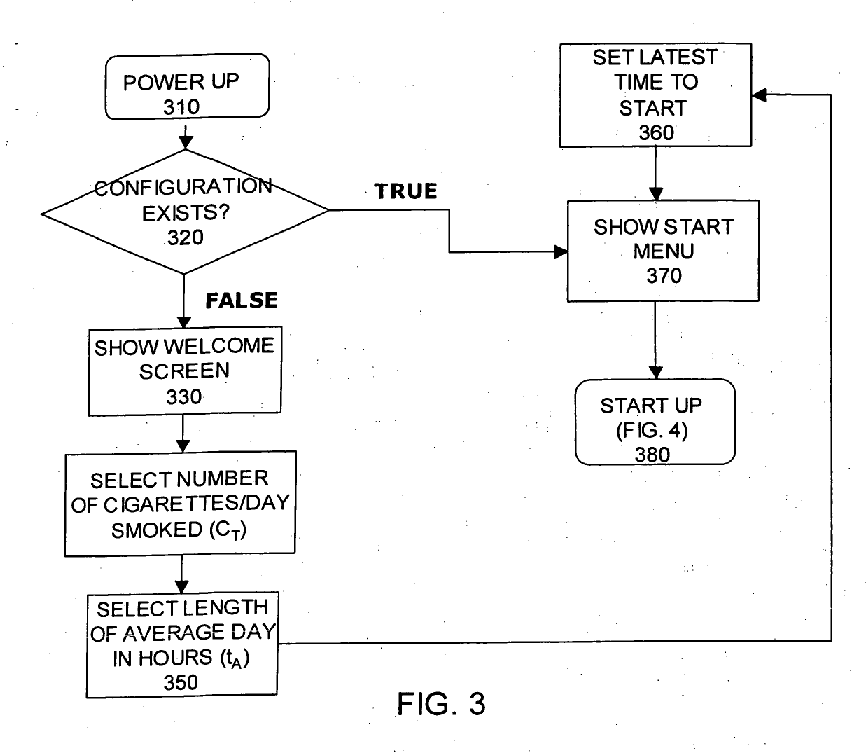

FIG. 3 shows an exemplary algorithm for a power up sequence for a smoking cessation plan. The algorithm in FIG. 3 may be implemented in software or hardware on one or more electronic or computer devices when either the device(s) is started, when the device is booted (or re-booted), or after the device is reset (or zeroed). When the device is powered up (block 310), a search can be performed to determine whether a configuration exists for a cessation of smoking program (block 320). The configuration can contain settings and/or data that a user has previously entered for the smoking cessation program. If a configuration already exists on the device, then a start menu (block 370) can be shown and the start up procedures (block 380) can begin.

If a configuration does not exist, then the user may be prompted to set up configuration data. When setting up configuration data, a screen may be displayed to welcome the user (block 330). The user can depress a button (e.g., the Start button) to bypass the welcome screen and to continue to the next configuration step. The user may be prompted to enter a number of cigarettes per day the user typically smokes (block 340). The user can then either enter a number or select a number from a menu. In one implementation, the user can be prompted to use the Function button to increment a number on the display to the number of cigarettes typically smoked in a day. In an embodiment, number of cigarettes smoked in a day can vary from 1 to 99, and the user can press the Select button to complete this step.

The user may then be prompted to enter a length of an average day in which they are likely to be active and/or smoking (block 350), e.g., awake. The user can either enter a number or select a number from a menu. In one implementation, an arrow key in the menu is shown to prompt the user to enter an average time they are awake in the day in 30 minute increments. In an embodiment, the average time awake can vary in the menu from 13 hours to 20 hours in a day.

The user may then be prompted to enter in the latest time of day they are likely to start the cessation smoking plan for that day. For example, a user may set a start time that is later in the day on the weekends. The latest start time setting can remind a user to start their program for that day if the user has not already started the program earlier that day. After the user enters the above configuration settings, the start menu can be shown (block 370) and the start up procedures can begin (block 380).

The algorithm in FIG. 3 may take into account the total amount of cigarettes the user smokes in one day and use a parameter for that amount, labeled “CT”. The algorithm may also take into account the average length of the smoker's day in minutes and use a parameter for that length, labeled “t_{A}”.

In another implementation, the exemplary algorithm for a power up sequence in FIG. 3 can be initiated when the device is reset or zeroed. In one aspect, a reset occurs when a power or battery unit is removed from the device. In the event the device has a battery back up unit, then the device can be reset by pressing and holding down the Start button, Select button, and the Function button simultaneously for 3 seconds.

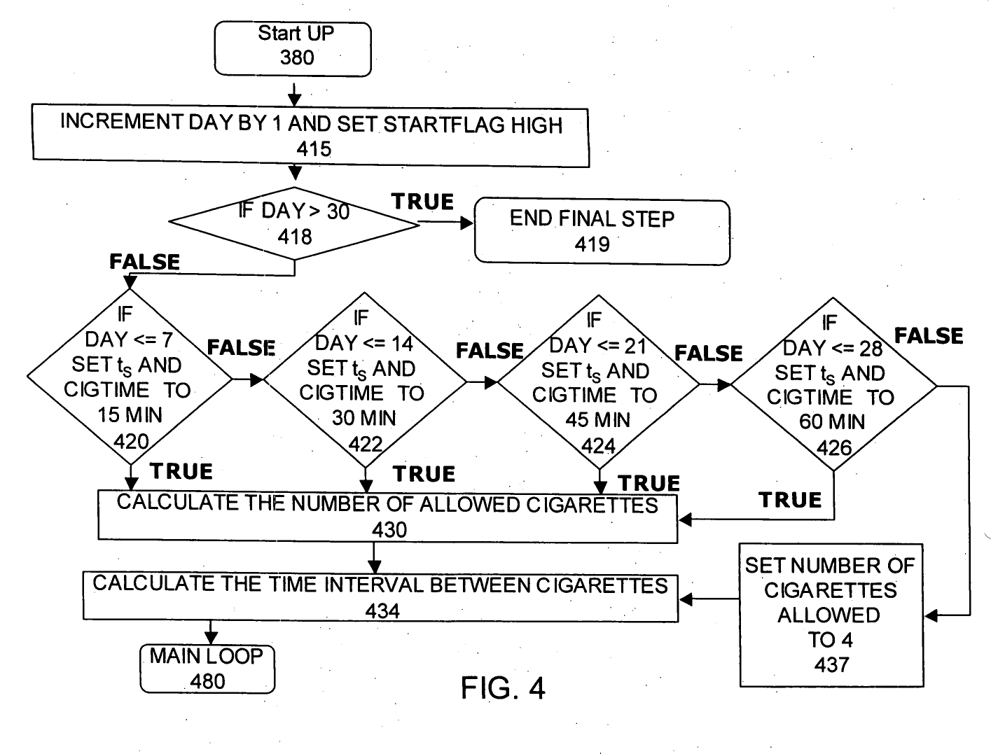

FIG. 4 shows an exemplary algorithm for settings and calculations in the smoking cessation plan. These initial settings and calculations can be described as part of several start up procedures in the algorithm. The algorithm in FIG. 4 can be intended to help a smoker to gradually reduce their dependence on using tobacco products, and create a weaning interval based on a 30-day cessation cycle. Although this implementation shows a 30-day cessation period, other cessation period length may be set in other implementations, such as cessation periods of 45 days or 60 days. As described in FIG. 3, the first phase of several start up procedures can begin when the power up sequence (FIG. 3) is complete. A “day number” can be set to 1 (e.g., first day) and an internal start flag or indicator can be set HIGH 415. The start flag or indicator may be a hardware or software implementation of a signal that can direct a device to display a day indicator to the user. If the day number is greater than 30 for a 30-day cessation period, then the start up procedures terminates (block 419). In this case, the smoking cessation plan has been completed.

If the day number is not greater than 30, then one of five phases can be performed based on the current day number. In each phase, in general, the number of cigarettes the user is allowed to smoke decreases on a weekly basis (e.g., 7 days) as the number of days increases toward the maximum number of days (e.g., 30 days) in the cessation period. Moreover, the time of day the first cigarette in allowed to be smoked is later in the day on a weekly basis as the number of days increases toward the maximum number of days in the cessation period. In each of the five phases in the cessation period, the smoker is allowed to smoke until 30 minutes prior to the end of the day (e.g., 10:30 pm minus 30 minutes) entered in the power up menu shown in FIG. 3.

For the first week (on or between days 1 and 7 in the plan), the time of the first cigarette the user is allowed to smoke can be 15 minutes after the user's start time in the day. For the second week (on or between days 8 and 14 in the plan), the time of the first cigarette the user is allowed to smoke can be 30 minutes after the user's start time in the day. For the third week (on or between days 15 and 21 in the plan), the time of the first cigarette the user is allowed to smoke can be 45 minutes after the user's start time in the day. For the fourth week (on or between days 22 and 28 in the plan), the time of the first cigarette the user is allowed to smoke can be 60 minutes after the user's start time in the day. For the fifth week (on or between days 29 and 30 in the plan), the time of the first cigarette the user is allowed to smoke can be 60 minutes after the user's start time in the day, and the total number of allowable cigarettes can be set to 4.

For the first four phases (i.e., the first four weeks) the algorithm utilizes a calculation of the total number of cigarettes the user is allowed to smoke in a day (block 430). For all of the five phases, the algorithm can utilize a calculation of a recommended time interval between cigarettes that a user is allowed to smoke in a day (block 434).

A first equation can be used for the device to calculate the number of cigarettes that are allowed to be smoked in a day. The first equation can be expressed as

$$C = {C}_{T} - ( \frac{{C}_{T} - 4}{29} ) * DAY \qquad ( 1 )$$

where C may be rounded to the nearest integer.

In the first equation, C_{T} represents the total amount of cigarettes the user typically smokes in a day at the beginning of the cessation plan (defined in the power up mode, FIG. 3). The DAY represents the number of the current day of the plan. The number of cigarettes that the user is allowed to smoke for a particular day is represented with C. The first equation can be used for the first four phases (i.e., the first four weeks) of the plan.

A second equation can be used by the device to calculate the recommended time interval between cigarettes that can be smoked by the user after the first cigarette is smoked for a given day. The second equation can be expressed as

$$Δ t = \frac{( {t}_{A} - 30 ) - {t}_{s}}{C - 1} \qquad ( 2 )$$

where Δt may be rounded to the nearest minute.

In the second equation, Δt represents the time interval between cigarettes that can be smoked by the user. The length of the smokers day (in minutes) is represented by t_{A}, and the time (in minutes) before the first cigarette is smoked is represented by tₛ.

The first and second equations can be implemented and/or defined in software and/or hardware. For example, a processor connected to the portable device can process the equations that are defined in software. After the second equation is calculated by the device, the start up procedures can end and the main operating loop (block 480) can begin.

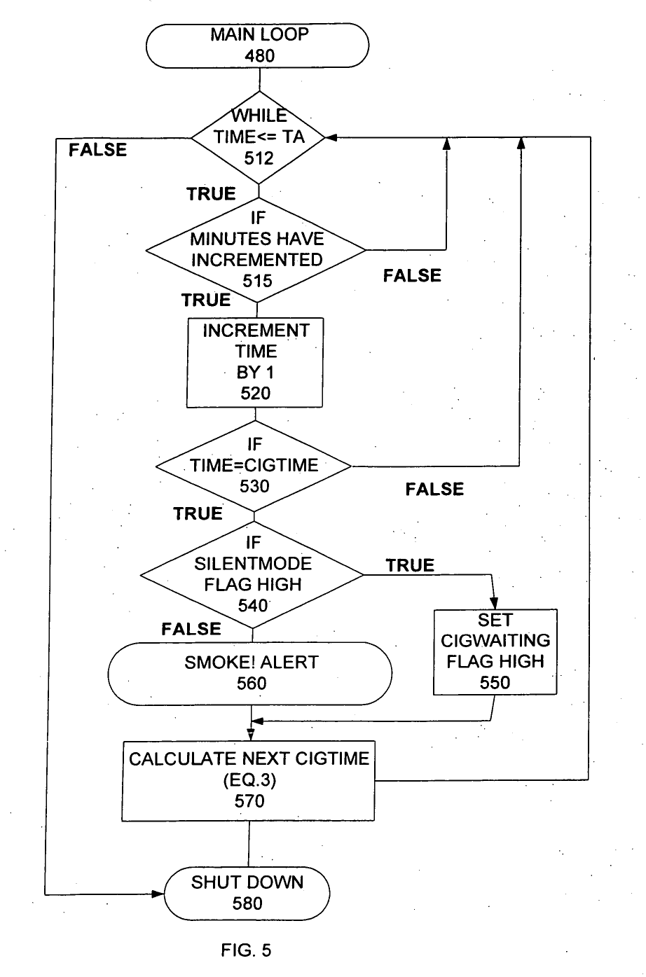

FIG. 5 shows an exemplary main operating algorithm of the smoking cessation plan. A smoking cessation device can normally use the main operating algorithm when the device is not running other algorithms in other modes, (e.g., the power up mode). The device can run the main operating algorithm for up to t_{A} minutes. The algorithm can have a TIME counter to store and update a number of minutes on or between 0 minutes and t_{A} minutes.

If the TIME count is greater than t_{A} minutes then the smoker's day is over and the device can shut down (block 580). If the TIME count is less than t_{A} minutes, the TIME count increments by 1 minute (blocks 515, 520), and then checks to see if the TIME count is equal to CIGTIME (block 530). CIGTIME represents a time when the user is allowed to smoke. If the TIME count is not equal to the CIGTIME (block 530) then the counter is incremented until either the TIME is greater than t_{A} minutes (block 512) or the TIME count is the same as the CIGTIME (block 530). If the TIME count is the same as CIGTIME then a check is made of a SILENTMODE indicator or flag to determine whether the device is in silent mode or a non-silent mode (e.g. audible mode, visual mode, vibrating mode) (block 540).

If the SILENTMODE flag is not HIGH (block 540), the device is not in the silent mode and the device can use a means to notify the user of an allowable time to smoke, i.e., the SMOKE! alert (block 560). The SMOKE! alert may be audible (e.g., beeping, honking, clicking, or chirping), visual (e.g., flashing lights and icons, or text messages), or physical (e.g., moving parts to create vibrations). The next CIGTIME may then be calculated using a third equation, which can be expressed as
CIGTIME=CIGTIME+Δt.

After the next CIGTIME is calculated (block 570), the TIME counter is checked 512 to see whether the count is greater than t_{A} minutes.

If the SILENTMODE indicator or flag is HIGH, then the device is in the silent mode. The CIGWAITING flag may be set HIGH (block 550) and the next CIGTIME can be calculated (block 570) using the third equation.

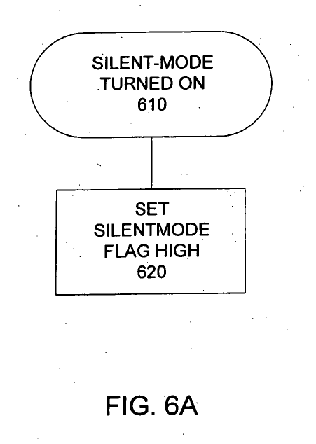

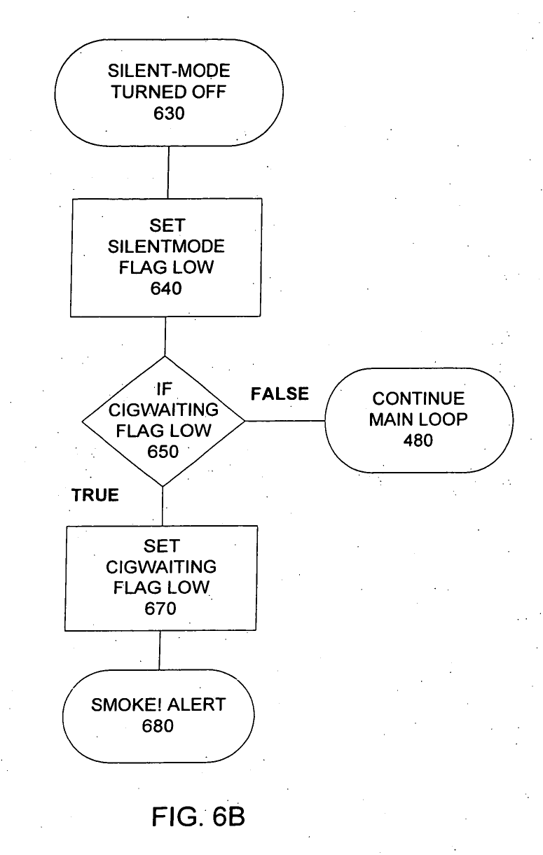

FIGS. 6A and 6B show exemplary flowcharts of silent mode operations. FIG. 6A shows an exemplary procedure when the silent mode is turned on (e.g., activated) (block 610). In this mode, the smoking cessation device is disabled from making an audible signal. The silent mode flag indicator SILENTMODE is set HIGH in the device or in software (block 620). The silent mode can be manually activated by the user toggling a button on the device (e.g., the Select button). The user can activate the silent mode at any time in the day when the user does not want to be audibly disturbed, such as during a meeting or a phone call. The interval calculations (described in FIGS. 4-5) can continue to operate in the background as normal, but no alert will occur at the calculated interval times. The silent mode feature can be automatically deactivated (e.g., reset) at the end of the day, and the user can choose to manually set the silent mode again at a time in the next day.

FIG. 6B shows an exemplary procedure when the silent mode is turned off (e.g., deactivated) (block 630). In this mode, the smoking cessation device is able to use audible indicators (e.g., beeping, honking, clicking, chirping), visual indicators (e.g., flashing lights and icons, text messages), and physical indicators (e.g., moving parts to create vibrations) to alert the user that the user is permitted to smoke at that time. The SILENTMODE flag SILENTMODE may be set LOW (block 640) and a determination is made (block 650) as to whether cigarettes were issued during the silent time. The CIGWAITING flag is checked to see if it is set high. If cigarettes were not issued during the silent time, then the operations continue in the main loop (block 480) (FIG. 5). If cigarettes were issued during the silent time, the CIGWAITING flag is set LOW (block 670), and the device uses one or more alerts (e.g., audible, visual, physical) to indicate that the user is currently allowed to smoke (block 680). The user can manually turn off the alert by pressing a button (e.g., the Start button). Alternatively, the alert will automatically turn off after a time period (e.g., 2 minutes).

When the device is in the silent mode, interval calculations may continue as normal but no alert is activated. When the silent mode is deactivated, and if cigarettes have been issued during the silent mode period, then the device may alert to award a cigarette. This may prevent the user from being overly penalized by being in the silent mode. In an embodiment, the next alert may come at the next calculated interval, as if the device had not been in the silent mode. In an alternative embodiment, a minimum time may be placed between the cigarette after the silent mode is deactivated and the next cigarette (e.g., 30 minutes). In another alternative embodiment, the next and subsequent CIGTIMEs may be calculated based on the time the silent mode is deactivated, i.e.,
CIGTIME=deactivation time+Δt.

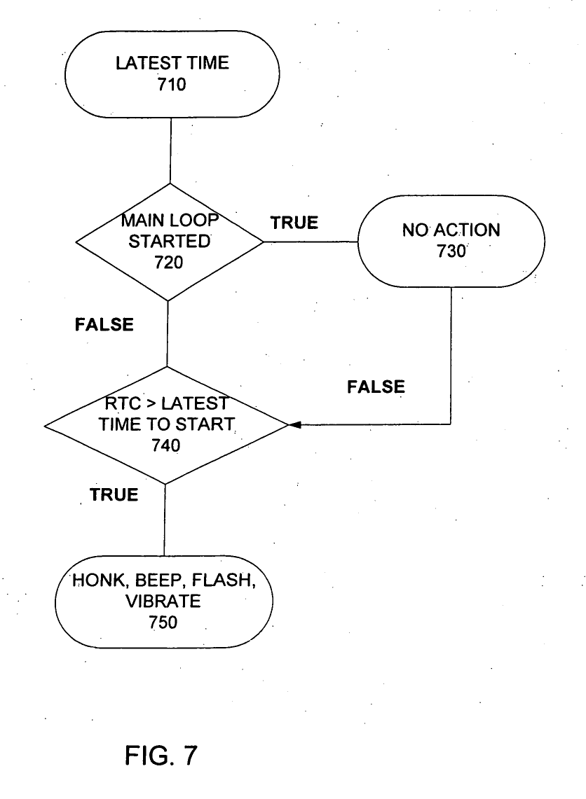

FIG. 7 shows an exemplary flow diagram with the latest time set in a day by a user (block 710). The latest time was described in regards to FIG. 3. The latest time to start is not part of the calculations, but it is based on the actual time of the day. The device may have a clock (e.g., a real time clock—RTC) that keeps track of the time of the day.

If the main operational loop has started (block 720), as shown in FIG. 5, then the smoking cessation program has already begun for that day, and the latest start time does not apply (block 730). If the smoking cessation program has not already begun for that day (e.g., RTC>latest time to start (block 740)), then the device can turn on an alert (e.g., audible, visual, physical) (block 750) that the user is permitted to smoke at that time.

The length of the weaning period (e.g., 30 days in the implementation described above) is a variable period of time per wean. The period could be from 5 to 60 days with the cigarette reduction being then calculated for the period.

Although the device has been described as a pager-type device, it may also be implemented in other easily transported devices (e.g., a credit card-size portable device). Also, the algorithm may be ported as a software program onto a user's existing portable devices (e.g., a pager, a personal digital assistant (PDA), or cellular phone).

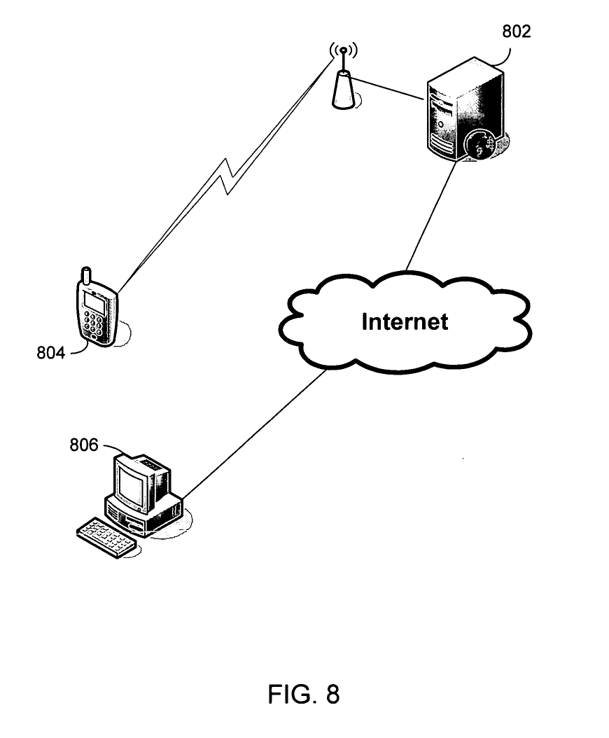

The device, e.g., cell phone, PDA, 2-way pager or other portable device with a CPU, may run the weaning protocol “on board” or may be in communication with a central server with the smoking cessation weaning instruction. In other words, the program for the smoking reduction could be resident on the device CPU or resident on a central server. FIG. 8 shows an embodiment in which the weaning protocol is resident on a central server 802. The program executes on the central server. When a smoking event occurred, the central server would then send an instruction to a wireless device 804 including the user interface using available wireless technology. The device would then alert the smoker it was time for the cigarette. In turn, after the smoker has acknowledged the alert, a signal would be wirelessly sent back to the central server where it would be stored in a database and available for the smoker to access. This would allow the user to subsequently track his smoking reduction progress via a self help website using a PC 806 or other web-accessible device. In this embodiment, the device 804 may include a controller to implement the silent mode operation and may send indicators to the server 102 identifying events including entering and exiting the silent mode.

The self help website would be the source of the database where the initial information regarding the smoker's current behavior (i.e. number of cigarettes smoked, hours of wakefulness, days to wean, device id to be contacted wirelessly) would be acquired and stored. This information would be used by the database/program to determine the weaning schedule and execute the weaning protocol.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

The software (also known as programs, software tools or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on one or more computers each having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface, portal, or a Web browser through which a user can interact with an implementation of the systems and techniques described here), or any combination of such back end, middleware, or front end components. The components of the system can be interconnected by any form or medium of digital data communication (e.g., a communication network).

Although only a few implementations have been described in detail above, other modifications are possible. There may be other value mapping scenarios not described. The user interfaces described above may be referred to as panels, palettes, pages, views, or portions of other interfaces. The logic flow depicted in the figures does not require the particular order shown, or sequential order, to achieve desirable results. The disclosed software may also allow a user to enter personalized information, such as a name of a program (e.g., “My stop smoking program”).

Other implementations may be within the scope of the following claims.

1. A method comprising:
receiving a user-input baseline number of cigarettes smoked per day;
receiving a user-input length of average day;
calculating a number of allowed cigarettes for a day in a smoking cessation plan in response to the user-input baseline number and a number representing the day;
calculating an interval between allowed smoking events in response to the calculated allowed number of cigarettes for the day, the user-input length of average day, and a start time corresponding to the day;
calculating a time for a next smoking event from a time for a previous smoking event and the calculated interval;
comparing a current time to the time for the next smoking event; and
alerting a user to smoke when the current time reaches the calculated time for the next smoking event.

2. The method of claim 1, further comprising:
displaying a number of cigarettes smoked up to the current time in the day; and
displaying the number representing the day.

3. The method of claim 1, wherein the day corresponds to one of a plurality of phases in the smoking cessation plan, each phase having an associated start time.

4. The method of claim 3, further comprising:
displaying an indicator corresponding to a current phase.

5. The method of claim 1, wherein the smoking cessation plan comprises a 30-day plan.

6. The method of claim 5, wherein said calculating the number of allowed cigarettes for a day comprises solving the equation
$$C = {C}_{T} - ( \frac{{C}_{T} - 4}{29} ) * DAY ,$$
where C is the number of allowed cigarettes for the day, C_{T} is the user-input baseline number of cigarettes, and DAY is the number representing the day.

7. The method of claim 6, wherein said calculating an interval between allowed smoking events comprises solving the equation
$$Δ t = \frac{( {t}_{A} - 30 ) - {t}_{s}}{C - 1} ,$$
where Δt is the interval, t_{A} is the user-input length of average day, and tₛ is the start time.

8. The method of claim 1, further comprising:
entering a silent mode in response to a first user selection;
ceasing to alert the user to smoke when the current time reaches the calculated time for the next smoking event in the silent mode;
exiting the silent mode in response to a second user selection;
determining if a smoking event occurred in the silent mode; and
alerting the user to smoke upon exiting the silent mode in response to a determination that a smoking event occurred in the silent mode.

9. The method of claim 8, further comprising:
calculating a time for a next smoking event from a time corresponding to exiting the silent mode and the calculated interval.

10. An apparatus comprising:
a user interface operative to receive a user-input baseline number of cigarettes smoked per day and a user-input length of average day;
a clock;
a processor operative to
calculate a number of allowed cigarettes for a day in a smoking cessation plan in response to the user-input baseline number and a number representing the day,
calculate an interval between allowed smoking events in response to the
calculated allowed number of cigarettes for the day, the user-input length of average day, and a start time corresponding to the day,
calculate a time for a next smoking event from a time for a previous smoking event and the calculated interval, and
compare a current time to the time for the next smoking event;
means for alerting a user to smoke when the current time reaches the calculated time for the next smoking event.

11. The apparatus of claim 10, further comprising:
a display operative to display a number of cigarettes smoked up to the current time in the day and the number representing the day in the smoking cessation plan.

12. The apparatus of claim 10, wherein the day corresponds to one of a plurality of phases in the smoking cessation plan, each phase having an associated start time.

13. The apparatus of claim 12, wherein the display is further operative to display an indicator corresponding to a current phase.

14. The apparatus of claim 10, wherein the smoking cessation plan comprises a 30-day plan.

15. The apparatus of claim 14, wherein said calculating the number of allowed cigarettes for a day comprises solving the equation
$$C = {C}_{T} - ( \frac{{C}_{T} - 4}{29} ) * DAY ,$$
where C is the number of allowed cigarettes for the day, C_{T} is the user-input baseline number of cigarettes, and DAY is the number representing the day.

16. The apparatus of claim 15, wherein said calculating an interval between allowed smoking events comprises solving the equation
$$Δ t = \frac{( {t}_{A} - 30 ) - {t}_{s}}{C - 1} ,$$
where Δt is the interval, t_{A} is the user-input length of average day, and tₛ is the start time.

17. The apparatus of claim 10, wherein the user interface further comprises user selection means, and
wherein the processor is further operative to
enter a silent mode in response to a first user selection;
deactivate the means for alerting the user to smoke when the current time reaches the calculated time for the next smoking event in the silent mode;
exit the silent mode in response to a second user selection;
determining if a smoking event occurred in the silent mode; and
control the means for alerting to alert the user to smoke upon exiting the silent mode in response to a determination that a smoking event occurred in the silent mode.

18. The apparatus of claim 17, wherein the processor is further operative to calculate a time for a next smoking event from a time corresponding to exiting the silent mode and the calculated interval.

19. The apparatus of claim 10, wherein the user interface, the clock, the processor, and the means for alerting are integrated in one of a pager-type device, a cellular phone, a PDA (Personal Digital Assistant), a watch, and a portable device dedicated to smoking cessation.

20. A system comprising:
a server including:
a transmitter to transmit wireless signals to a client device;
a receiver to receive wireless signals from the client device;
a clock;
a processor operative to
receive a user-input baseline number of cigarettes smoked per day and a user-input length of average day received from the client device,
calculate a number of allowed cigarettes for a day in a smoking cessation plan in response to the user-input baseline number and a number representing the day,
calculate an interval between allowed smoking events in response to the
calculated allowed number of cigarettes for the day, the user-input length of average day, and a start time corresponding to the day,
calculate a time for a next smoking event from a time for a previous smoking event and the calculated interval, and
compare a current time to the time for the next smoking event; and
means for generating and transmitting an indicator to the client device, said indicator operative to alert a user to smoke when the current time reaches the calculated time for the next smoking event.

21. The system of claim 20, further including the client device, wherein the client device comprises:
means for alerting the user to smoke in response to receiving the indicator from the server; and
a controller operative to:
enter a silent mode in response to receiving a first a first user selection;
deactivate the means for alerting the user to smoke when the current time reaches the calculated time for the next smoking event in the silent mode;
exit the silent mode in response to a second user selection;
determining if a smoking event occurred in the silent mode; and
control the means for alerting to alert the user to smoke upon exiting the silent mode in response to a determination that a smoking event occurred in the silent mode.

22. The apparatus of claim 21, wherein the client is operative to transmit an indicator to the server in response to the controller entering the silent mode, and
wherein the server is further operative to calculate a time for a next smoking event from a time corresponding to exiting the silent mode and the calculated interval.

23. The apparatus of claim 20, wherein the client device comprises one of a pager-type device, a cellular phone, a PDA (Personal Digital Assistant), a watch, and a portable device dedicated to smoking cessation.
